(19) United States
(12) Patent Application Publication
(10) Pub. No.: US 2023/0184430 A1
(43) Pub. Date: Jun. 15, 2023

(54) METHOD AND APPARATUS FOR INCINERATING WASTE

(71) Applicant: MARTIN GmbH fur Umwelt- und Energietechnik, Munchen (DE)

(72) Inventors: Sebastian Josef Jell, Munchen (DE); Max Josef Schonsteiner, Munchen (DE); Johannes Ulrich Martin, Munchen (DE)

(21) Appl. No.: 18/080,457

(22) Filed: Dec. 13, 2022

(30) Foreign Application Priority Data
Dec. 15, 2021 (DE) DE102021006192.6

(51) Int. Cl. F23G 5/50

(52) U.S. Cl. CPC F23G 5/50; F23G 2207/30; F23G 2900/00001; F23N 2241/18

(57) ABSTRACT

Exemplary arrangements relate to a method for incinerating waste on a combustion grate of a furnace and an apparatus for carrying out such a method. Oxygen mixed with carrier gas is supplied to the combustion for incineration as an oxygen and carrier gas mixture. The carrier gas comprises recirculated combustion gas from the furnace and may have a CO₂ concentration of from 10% to 99%.

### TECHNICAL FIELD

Exemplary arrangements relate to a method for incinerating waste on a combustion grate of a furnace and an apparatus for carrying out such a method.

### BACKGROUND

A feature of many waste incineration plants is that only low concentrations of CO₂ are present in the waste gases. This is advantageous in one respect. On the other hand, the separation of the residual CO₂ is complex and cost-intensive, as relatively large quantities of gas have to be treated. These large volumes of flue gas require the use of sophisticated flue gas treatment plants, for which components for separating carbon dioxide are not normally cost effective.

The oxygen enrichment of the primary combustion air delivered to the combustion zone of the furnace does result in a reduction in the quantity of flue gas. But the enrichment of the combustion air is limited, as the substitution of atmospheric oxygen with pure oxygen due to the increased adiabatic combustion temperature, constitutes a high thermal load for the incineration plant. Moreover, regulation is difficult because allowance must be made for the delayed reaction of the entire plant to a change in the oxygen supply.

Existing methods and systems for waste incineration may benefit from improvements.

### SUMMARY

Exemplary arrangements include a method for incinerating waste in such a manner that the separation of the CO₂ in the flue gas is simplified. Exemplary arrangements further include an apparatus for carrying out a method for incinerating waste on a combustion grate of a furnace.

The method according to an exemplary arrangement provides that when waste is incinerated on a combustion grate of a furnace, oxygen is added to the combustion with a carrier gas as an oxygen and carrier gas mixture, and the carrier gas comprises recirculated gas from the furnace with a CO₂ concentration from 10 to 99% by volume. Accordingly, an oxygen and carrier gas mixture is added to the incineration, and in this oxygen and carrier gas mixture the carrier gas itself contains a carrier gas mixture that includes 10 to 95% CO₂. The consequence of this is that ultimately oxygen is supplied to the combustion for the incineration with CO₂ and possibly with other gases. The effect of this is that the concentration of CO₂ in the waste gas of the incineration plant increases and it becomes easier to regulate the plant by means of the supplied gases.

The consequence of this is that due to the higher concentration of CO₂ in the waste gas, it becomes easier to separate the CO₂ from the waste gas. In addition, the quantities of flue gas are reduced, since the carrier gas is extracted from the flue gas. The combustion temperatures can also remain in a suitable range for the operation of components.

In exemplary arrangements oxygen may be delivered to a combustion zone in addition to the oxygen and carrier gas mixture. DE 102 13 788 B4 and DE 102 13 790 describe waste incineration plants with combustion regulation that includes oxygen enrichment of the primary combustion air up to 25 vol% to 40 vol%.

In this context, the oxygen enrichment of the primary air may be used to improve the quality of the slag by raising the temperatures in the combustion bed due to the higher oxygen level, thereby sintering the slag. This may be done in some arrangements to achieve better binding of the harmful substances.

However, methods of such kind may be complicated from both the regulation and process engineering perspectives, and the improved slag quality may not justify the expense in some arrangements.

In a method of some exemplary arrangements, it is useful if the oxygen and carrier gas mixture is added with an oxygen concentration from 5 to 40% and in other arrangements from 16 to 40% by volume. This means that more than half of the oxygen and carrier gas mixture is carrier gas.

The oxygen and in particular the oxygen and carrier gas mixture may be supplied to both the primary combustion zone and the secondary combustion zone of the furnace. In exemplary arrangements at least a fraction of the oxygen is added to the primary combustion zone and/or the secondary combustion zone. In some arrangements the furnace may have a plurality of separate disposed combustion zones. The gas fractions in the oxygen and carrier gas mixture may be selectively varied for delivery in different combustion zones. The gas fractions may be selectively varied for each combustion zone in a set of combustion zones. Numerous different approaches may be used.

In some exemplary arrangements since the concentration of CO₂ in the combustion gas recirculated from the furnace is at a level from 10 to 99%, the carrier gas contains yet another gas fraction, which in some arrangements is air and in particular arrangements atmospheric air. The recirculated combustion gas can contain a high quantity of CO₂, and the CO₂ gas produced by a separating device can have a degree of purity from 80 to 99% CO₂. In some arrangements before the recirculated combustion gas is added to the combustion, it may be adjusted to the needs of the incineration operation, and mixed with air for example. Such arrangements make it possible to adjust the CO₂ content for individual combustion situations. In some exemplary arrangements the mixture of gas added to the furnace may contain between 30 and 84% CO₂. This makes it possible to maintain a minimum O₂ content of 16%, in order to keep the combustion going.

In some exemplary arrangements the recirculated combustion gas is extracted from the furnace after the waste gas has undergone treatment.

In some exemplary arrangements the recirculated combustion gas is supplied to the primary combustion zone.

In some exemplary arrangements to influence the incineration on the combustion grate, and to regulate it as well, the concentration of gas fractions in the oxygen and carrier gas mixture may be selectively varied.

In exemplary arrangements in which the combustion grate which supports waste being incinerated has multiple combustion zones, the concentration of the gas fractions in the oxygen and carrier gas mixture in the zones may be selectively varied in order to influence the incineration action on the combustion grate. The concentration of the gas fractions in the oxygen and carrier mixture in some arrangements may be varied even within the zones, in order to regulate the incineration on the combustion grate.

The exemplary method makes it possible to supply at least a part of the waste gas from the furnace to a post-processing step, in which the CO₂ is separated.

The exemplary apparatus provides that recirculation gas feed lines with a port for recirculation gas and/or oxygen feed lines with a port for oxygen and/or an air line with a port for air, are arranged underneath the combustion grate. This makes it possible to combine recirculation gas and/or oxygen and/or air, and/or also to introduce them to the combination zone where waste incineration occurs, separately immediately below the combustion grate.

In some exemplary arrangements an incineration plant has at least one secondary air feed above the combustion grate, which includes a port for air and/or recirculation gas, a valve and a secondary air nozzle in the flow direction, wherein an oxygen feed line with a port for oxygen is arranged between the valve and the secondary air nozzle.

Such exemplary arrangements make it possible to supply recirculation gas and/or oxygen and/or air as the primary combustion gas and/or as the secondary combustion gas depending on the requirements profile.

In some exemplary arrangements it is possible to supply oxygen from a hydrogen production operation to the furnace of an incineration plant, and to simplify the separation of CO₂ in the flue gas by increasing the CO₂ content and reducing the nitrogen fraction in the flue gas of the furnace.

Further details of exemplary arrangements will be explained in the following Detailed Description.

### BRIEF DESCRIPTION OF DRAWINGS

FIG. 1 is a schematic cross-sectional representation of components of an exemplary incineration plant.

FIG. 2 is a schematic diagram of an exemplary incineration plant and the material flows.

### DETAILED DESCRIPTION

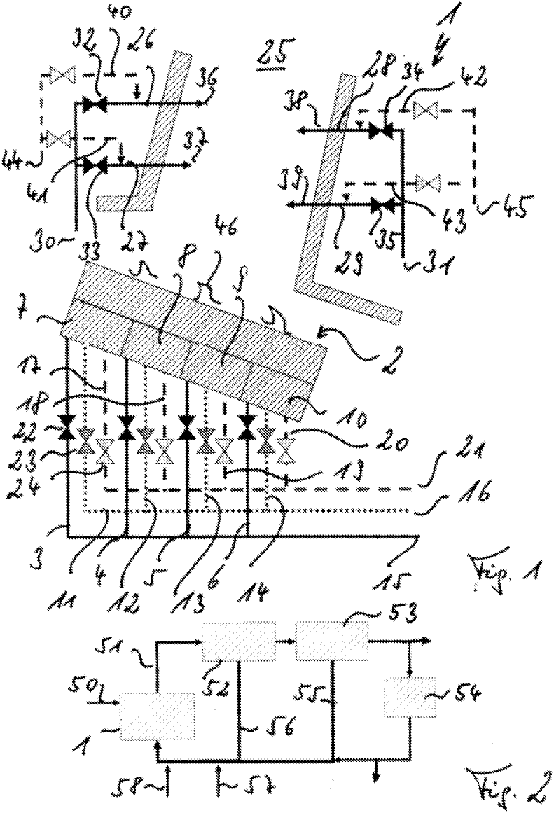

The exemplary incineration furnace shown in FIG. 1 has a combustion grate 2, to which primary air feed lines 3, 4, 5 and 6 lead. These primary air feed lines 3, 4, 5 and 6 lead to outlets in individual combustion zones 7, 8, 9 and 10 of the combustion grate 2. Besides the primary air feed lines 3, 4, 5 and 6, recirculation gas feed lines 11, 12, 13 and 14 are located to deliver gas under the combustion grate 2. The primary air feed lines 3, 4, 5 and 6 have a port 15 for delivery of primary air, the recirculation gas feed lines 11, 12, 13, and 14 have a port 16 for delivery of recirculation gas, and the oxygen feed lines 17, 18, 19 and 20 have a port 21 for delivery of oxygen.

Valves 22, 23 and 24 (numbered for exemplary purposes only) in the primary air feed lines 3, 4, 5 and 6, in the recirculation gas feed lines 11, 12, 13 and 14 and in the oxygen feed lines 17, 18, 19 and 20 make it possible to supply different gases and mixtures thereof to the combustion grate 2, tuned highly selectively to the individual combustion zones 7, 8, 9 and 10.

Above the exemplary waste supporting combustion grate 2, the waste gas flue 25 is furnished with secondary air feed lines 26, 27, 28 and 29, which have a separate or common port 30, 31 for delivery of air and/or recirculation gas. In the exemplary arrangement each secondary air feed line includes a valve 32, 33, 34 and 35 to allow the supply of air and/or recirculation gas to be adjusted or regulated. The air and/or the recirculation gas are fed in controlled manner via valves 32, 33, 34 and 35 to secondary air nozzles 36, 37, 38 and 39, via which the secondary air reaches the waste gas flue 25. Oxygen feed lines 40, 41, 42 and 43 are arranged between each of the valves 32, 33, 34 and 35 and the secondary air nozzles 36, 37, 38 and 39, and each feed line has a port 44, 45 for delivery of oxygen.

In this way, secondary air in the waste gas flue 25 can also be supplied as air and/or recirculation gas via the nozzles 36, 37, 38 and 39. Numerous different combinations and amounts of the mixture of oxygen and carrier gas, oxygen, air and recirculated combustion gas may be delivered via outlets from conduits above and below the exemplary combustion grate.

When the exemplary furnace 1 is in use, waste 46 is incinerated supported on the combustion grate 2, via combustion, and during the incineration oxygen is forwarded to the combustion grate 2 via lines 17, 18, 19 and 20 and oxygen is forwarded to the waste gas flue 25 via lines 40, 41, 42 and 43. This oxygen is supplied together with recirculation gas, which can be added via ports 16, 30 and 31.

FIG. 2 is a schematic representation of a method according to an exemplary arrangement. Fuel 50 is supplied to the furnace 1, and the flue gases 51 are forwarded to heat recovery 52 and from there to waste gas purification 53. From waste gas purification 53, the waste gas 51 passes to post-treatment in a separate device 54, in which CO₂ is separated. After the post-treatment 54, at least a portion of the waste gas is returned as recirculated combustion gas to the furnace 1. Waste gas streams 55 and 56 from waste gas purification 53 or from heat recovery 52 may be fed to this waste gas stream from the post-processing separate device 54 for firing 51. A feed line 57 for air and a feed line 58 for oxygen are also provided.

Thus the exemplary arrangements achieve improved operation, eliminate difficulties encountered in the use of prior devices, systems and methods, and attain the useful results described herein.

In the foregoing description, certain terms have been used for brevity, clarity and understanding. However no unnecessary limitations are to be implied therefrom because such terms are used for descriptive purposes and are intended to be broadly construed. Moreover the descriptions and illustrations herein are by way of examples and the new and useful features are not limited to the exact features that have been shown and described.

Having described features, discoveries and principles of the exemplary arrangements, the manner in which they are constructed and operated, and the advantages and useful results attained, the new and useful features, devices, elements, arrangements, parts, combinations, systems, equipment, operations, methods, processes and relationships are set forth in the appended claims.

We claim:

1. A method comprising:
a) incinerating waste supported on a combustion grate of a furnace via combustion,
b) during at least a portion of (a), adding an oxygen and carrier gas mixture to the combustion,
wherein the carrier gas comprises recirculated combustion gas produced by the combustion within the furnace with a CO₂ concentration of from 10% to 99%.

2. The method according to claim 1
wherein in (b) the oxygen and carrier gas mixture has an oxygen concentration by volume of from 5% to 40% of the mixture.

3. The method according to claim 1
wherein in (b) the oxygen and carrier gas mixture has an oxygen concentration by volume of from 16% to 40% of the mixture.

4. The method according to claim 1
wherein in (b) the oxygen and carrier gas mixture is added to the combustion in a primary combustion zone of the furnace.

5. The method according to claim 1
wherein in (b) the oxygen and carrier gas mixture is added to the combustion in a secondary combustion zone of the furnace.

6. The method according to claim 1
wherein in (b) the oxygen and carrier gas mixture is added to the combustion in both a primary combustion zone of the furnace and in a secondary combustion zone of the furnace.

7. The method according to claim 1
wherein in (b) the oxygen and carrier gas mixture further comprises air.

8. The method according to claim 1
wherein in (b) the oxygen and carrier gas mixture further comprises atmospheric air.

9. The method according to claim 1, and further comprising:
prior to (b), extracting waste combustion gas from the furnace, and treating the waste combustion gas,
wherein in (b) the carrier gas comprises the treated waste combustion gas.

10. The method according to claim 1, and further comprising:
varying the gas fractions in the oxygen and carrier gas mixture,
whereby in (a) incinerating properties are varied.

11. The method according to claim 1
wherein in (a) the combustion grate includes a plurality of disposed combustion zones in which incinerating occurs,
wherein in (b) the oxygen and carrier gas mixture is delivered via delivery conduits in a plurality of the combustion zones.

12. The method according to claim 1
wherein in (a) the combustion grate includes a plurality of disposed combustion zones in which incinerating occurs,
wherein in (b) the oxygen and carrier gas mixture is delivered in a plurality of the combustion zones,
and further comprising:
varying the gas fractions of the oxygen and carrier gas mixture,
wherein the gas fractions of the oxygen and carrier gas mixture that is delivered in one of the combustion zones in (b) differs from the gas fractions of the oxygen and carrier gas mixture that is delivered in at least one of the other combustion zones in (b).

13. The method according to claim 1
wherein in (a) the combustion grate includes a plurality of disposed combustion zones in which incinerating occurs,
wherein in (b) the oxygen and carrier gas mixture is delivered in a plurality of the combustion zones,
and further comprising:
varying the gas fractions of the oxygen and carrier gas mixture,
wherein the gas fractions of the oxygen and carrier gas mixture that is delivered in (b) in each combustion zone of a set including a plurality of zones, differs from the gas fractions of the oxygen and carrier gas mixture that is delivered in (b) in each of the other combustion zones of the set.

14. The method according to claim 1, and further comprising:
prior to (b), delivering waste gas from the furnace to a separating device that separates CO₂ from the waste gas,
wherein in (b) the recirculated combustion gas includes gas separated by the separating device.

15. The method according to claim 1, and further comprising:
during at least a portion of (a) additionally adding separately at least one of air and oxygen to the combustion.

16. The method according to claim 1
wherein in (b) the mixture of oxygen and carrier gas is added both above and below the combustion grate.

17. The method according to claim 1, and further comprising:
during at least a portion of (a) separately adding air to the combustion, both above and below the combustion grate.

18. The method according to claim 1, and further comprising:
during at least a portion of (a) separately adding oxygen to the combustion, both above and below the combustion grate.

19. A method comprising:
a) carrying out combustion within an interior area of a furnace to incinerate waste,
b) during at least a portion of (a) adding a mixture comprised of oxygen and carrier gas to the interior area of the furnace, wherein the carrier gas comprises recirculated combustion gas produced by the combustion within furnace with a CO₂ concentration of from 10% to 99%.

20. Apparatus comprising:
a furnace,
wherein the furnace includes an internal combustion grate,
wherein the furnace is configured to incinerate waste supported on the combustion grate via combustion in a combustion zone,
a separating device,
wherein the separating device is operative to
receive combustion gas produced by the furnace during combustion, and
separate CO₂ from the combustion gas produced by the furnace,
at least one conduit operative to deliver a mixture of oxygen and the CO₂ separated from the combustion gas into the combustion zone.
